(19) United States
(12) Patent Application Publication
(10) Pub. No.: US 2017/0345523 A1
(43) Pub. Date: Nov. 30, 2017

(54) ISOTOPE PRODUCTION APPARATUS

(71) Applicant: Ion Beam Applications, S.A., Louvain-la-Neuve (BE)

(72) Inventors: Benoît Nactergal, Horrues (BE); Frédéric Stichelbaut, Mazy (BE)

(73) Assignee: Ion Beam Applications, S.A.

(21) Appl. No.: 15/605,507

(22) Filed: May 25, 2017

(30) Foreign Application Priority Data
May 25, 2016 (EP) 16171282.3

(51) Int. Cl. G21G 1/10; H05H 13/00

(52) U.S. Cl. CPC G21G 1/10; H05H 13/005

(57) ABSTRACT

The present disclosure relates to an isotope production apparatus. In one implementation, the apparatus may include a cyclotron for producing a particle beam, a shielding surrounding the cyclotron, and a target system within the shielding. The shielding may include a first layer having a hydrogen content of at least 100 kg/m³ and a second layer having at least 4900 kg/m³ of material having an atomic number equal to or higher than 26, and at least 29 kg/m³ of hydrogen.

This application claims the benefit of priority of European Patent Application No. 16171282.3, filed on May 25, 2016, which is incorporated herein by reference.

### TECHNICAL FIELD

The present disclosure relates to an isotope production apparatus and more specifically to an isotope production apparatus comprising a shielding.

### BACKGROUND

Cyclotrons used to produce PET radioisotopes generate important fluxes of secondary neutrons and photons around the ¹⁸F targets. In order to reduce the radiation doses to acceptable levels for human personnel, they need to be enclosed in a shielding vault made of thick concrete walls. An exemplary Cyclone® 10/5, Cyclone® 11 or Cyclone® 18/9 cyclotron, from Ion Beam Applications, producing proton beams with an energy of 10 MeV, 11 MeV or 18 MeV respectively, with an intensity of 40 μA needs about 2 m thick concrete walls and 1.8 m thick roof. Such a massive bunker is not easy to install in an existing hospital and usually requires new installation dedicated to this cyclotron. Such Isotope production apparatuses comprising a cyclotron and a target system must be shielded. In one known design of isotope production apparatus represented at FIG. 1, the cyclotron 10 and the target 20 are located in a vault shielding 30. The thickness of the vault shielding and the material of the vault shielding are selected such that the dose rate at the external surface of the vault shielding is less than a limit. When the area outside the vault shielding 30 is a controlled area, this limit is 10 μSv/h. When the area outside the vault shielding is a public area, this limit is 0.5 μSv/h. This limit ensures that a member of the public, staying 2000 hours per year or less in this area, will receive a total dose less than 1 mSv in a year. The vault shielding material is usually concrete. The area inside the vault shielding 30 is not accessible to service personnel during beam production. For a typical cyclotron producing a 18 MeV proton beam, for the production of FDG, the thickness a vault shielding made of concrete should be about 220 cm or 240 cm.

In order to reduce the cost and volume of the shielding, another type of isotope production apparatus represented at FIG. 2 has been designed, in which the cyclotron 10 and the target 20 are closely encompassed by an encompassing shielding 40. Such design is known as self-shielded system. Being very close to the radiation sources, such a self-shielding 40 can be very compact and allows a sensible reduction of the total shielding weight. A self-shielding, being close to the cyclotron, does not allow penetration of service personnel inside the shielding. Therefore it must be made of moveable parts in order to allow an easy access to the cyclotron for maintenance. These systems are then enclosed in a room having an additional vault shielding 35. The wall thickness of this additional vault shielding 35 required for meeting the dose rate in the area outside of the shielding is much lower than in vault shielding systems. When a 18-MeV cyclotron is enclosed in a self-shielding, the thickness of a concrete wall of the accelerator chamber may be as thin as 25 cm but preferably from 30 to 60 cm thick, or even 80 cm for a cyclotron producing a 150 μA beam.

Document WO2007141223 generally relates to a self-shielded system, wherein the shielding encompasses a target. The shielding may comprise a shell filled with radiation absorbing material. In an outer region the shell may be filled with a high Z compound such as lead or iron and in an inner region the shell may be filled with a low Z compound such as polyethylene or a paraffin compound. The thickness of the shielding is 85 cm around the cyclotron and 60 cm above it. This shielding was designed for encompassing a 11 MeV cyclotron.

Document WO2010151412 generally relates to an isotope production apparatus comprising a cyclotron and a target system located at a distance of the cyclotron. The magnet yoke of the cyclotron attenuates the radiation emitted from within the cyclotron. In order to effectively shield this radiation, the magnet yoke may be thicker than what is required to form the desired magnetic field. Furthermore, the cyclotron may be operated at a low energy that produces a relatively low amount of neutral particles. For example, the cyclotron may bring the charged particles to an energy level of approximately 9.6 MeV or, more specifically, 7.8 MeV or less. The target system is shielded by a first or inner shielding structure and a second or outer shielding structure that surrounds the first shielding structure. The first shielding structure surrounds the target and attenuates gamma radiation. This first shielding structure may be formed from mostly lead (Pb). The second shielding structure surrounds the first shielding structure is configured to attenuate the neutrons and also the gamma rays emitted from the target region and also to attenuate gamma rays generated by neutron capture. The second shielding structure may include polyethylene, lead (Pb) and boron in smaller amounts. In one particular embodiment, the second shielding structure includes about 80% polyethylene (including 3% boron) and about 20% lead (Pb). However, the selection of materials and ordering of the layers may not be optimal.

The task of designing an efficient shielding for an isotope production apparatus is a complex task, because the shielding must attenuate neutrons produced in the target system as a consequence of the nuclear reaction induced by the particle beam, the photons produced in the target system or in the cyclotron itself, and secondary photons resulting from the interaction of neutrons in the shielding.

### SUMMARY

Embodiments of the present disclosure may provide a self-shielded isotope production apparatus having a shielding meeting dose rate requirements with a shielding that is more compact than prior art shieldings. More specifically, the self-shielded isotope production apparatus, when installed in a room having a shielding wall of 60 cm of regular concrete must produce a dose rate less than 0.5 μSv/h outside of said shielding wall. When installed in a room having a shielding wall of 20 cm of regular concrete, it must produce a dose rate less than 10 μSv/h outside of said shielding wall. The first condition applies to a public area and the second condition applies to a controlled area. In the context of the present disclosure, the term “regular concrete” is to be understood as the composition of material #99 defined in “Compendium of Material Composition Data for Radiation Transport Modeling”, PNNL-15870 Rev. 1., Pacific Northwest National Laboratory, or an equivalent thereof. The density of this composition is 2.3 g/cm³.

Some embodiments of the present disclosure are defined by the independent claims. The dependent claims define further embodiments.

According to some embodiments of the present disclosure, there is provided an isotope production apparatus comprising:

a) a cyclotron for producing a particle beam;

b) a shielding encompassing said cyclotron;

c) a target system comprised within said shielding;

The shielding may comprise:
1) a first layer having a hydrogen content of at least 100 kg/m³;
2) a second layer comprising at least 4900 kg/m³ of material having
an atomic number equal to or higher than 26, and at least 29 kg/m³ of hydrogen.

Said first layer may comprise paraffin and/or polyethylene and/or water.

Said second layer may comprise a volume filled with iron balls and with water filling the open spaces between the iron balls.

Said ratio of the thickness of the second layer to the thickness of the second layer may be between 1 and 2.

Said first layer may have a thickness comprised between 25 and 30 cm.

Said second layer may have a thickness comprised between 50 and 60 cm.

Said cyclotron may comprise a magnet having a central axis Z and wherein a cross-section normal to the central axis Z of the outer surface of said magnet has a circular geometry concentric with the central axis Z.

As an alternative, said cyclotron may also comprise a magnet having a central axis Z, wherein a cross-section normal to the central axis Z of the outer surface of said magnet has a geometry inscribed in a square concentric with the central axis, Z, and wherein said closely encompassing shielding comprises four side walls adjacent to said square and a roof covering said four sides.

In this alternative, the target system may comprise one target or two targets, said targets being at azimuthal angles around central axis Z closest to a side wall, a side wall adjacent to a target having a thickness higher than a side wall non-adjacent to a target.

The external angles between a pair of side walls and/or between a side walls and the roof may be cut off.

The cut-off may be a 45° cut-off at a distance comprised between 25 cm and 50 cm from the external angles.

### SHORT DESCRIPTION OF THE DRAWINGS

These and further aspects of the present disclosure will be explained in greater detail by way of example and with reference to the accompanying drawings in which:

FIG. 1 represents schematically a top view of a known isotope production apparatus in a vault shielding.

FIG. 2 represents schematically a top view of another known isotope production apparatus having a self-shielded cyclotron and target system inside an additional vault shielding.

FIGS. 3a and 3b are side and top and view respectively of an isotope production apparatus having an encompassing shielding.

FIGS. 4, 5, 6, 7 and 8 are example graphs of sets of dose rate values obtained at different locations and related to the examples 1, 2, 3, 3′, 4 respectively.

FIGS. 9, 10, 11 and 12 are example graphs of sets of dose rate values obtained at different locations and related to the examples 5, 6, and 7 and 8 respectively.

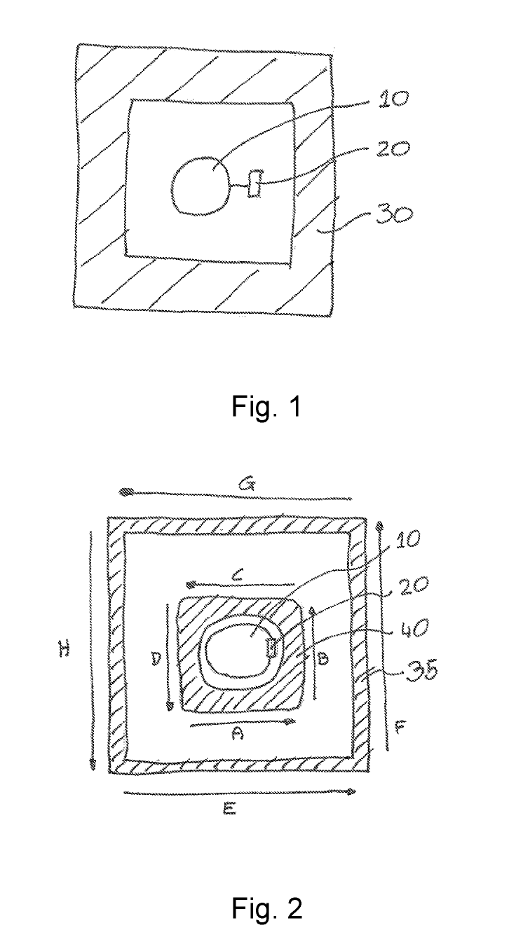

In all these graphs, dose rates are shown for the neutrons (squares), the photons (triangles) and total doses (circles) in μSv/h on a logarithmic scale. The significant limits of 0.5 μSv/h (public area outside of shielding), 10 μSv/h (controlled area outside of shielding) and 100 μSv/h are marked as horizontal dotted lines. For the first graph of each set, the dose rates are determined along a line marked by the arrows A, B, C, D of FIG. 2, i.e. at the external surface of the encompassing shielding, from 0 to 1450 cm. For the 5 subsequent graphs, the dose rates are determined along a line marked by the arrows E, F, G, H of FIG. 2, i.e. at the external surface of the additional vault shielding, from 0 to 26 m. Results for different thicknesses of the additional vault shielding are shown, namely 0 cm (no shield), 20 cm, 40 cm, 60 cm and for some examples 80 cm.

The drawings of the figures are neither drawn to scale nor proportioned. Generally, identical components are denoted by the same reference numerals in the figures.

### DETAILED DESCRIPTION

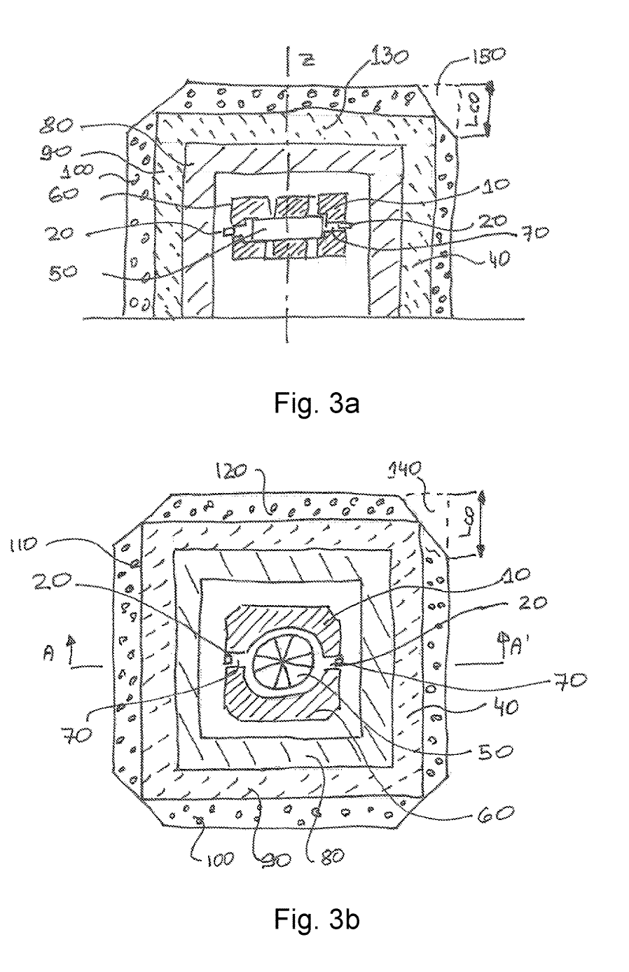

FIG. 3a is a side view of a section across plane represented as A-A′ in FIG. 3b of an isotope production apparatus. As depicted in FIG. 3a, a cyclotron 10 comprises an accelerator chamber 50. The acceleration chamber 50 is located between the upper and lower poles of the magnet (not shown) and accelerates particle in a plane perpendicular to a central axis Z. The return yoke 60 of the magnet surrounds the acceleration chamber 50 and is provided with apertures 70 for different utilities for the cyclotron 10. Among these utilities are one or more targets 20, located in these apertures. The beam may be extracted and directed to the targets 20 by known means, such as stripping, when the accelerated particles are H ions. The cyclotron is encompassed by a shielding 40. The encompassing shielding 30 comprises side walls 110 and a roof 130 covering the side walls 110 and the cyclotron. Side walls and roof comprise successive layers of material having different thicknesses and compositions according to the different examples discussed below. A first layer 80 has a thickness L1 in the side walls and in the roof. A second layer 90 may have a thickness L2_{target} in the side walls located adjacent to a target 20, a thickness L2_{non-target} in the side walls not located adjacent to a target 20 and a thickness L2ₜₒₚ in the roof. A third layer 100 is optional as will be seen in the different examples below and may have a thickness L3_{target} in the side walls located adjacent to a target 20, a thickness L3_{non-target} in the side walls not located adjacent to a target 20 and a thickness L3ₜₒₚ in the roof.

FIG. 3b is a top view of the same isotope production apparatus in a section across the mid plane the cyclotron 10. As will be discussed later, the thickness of the second layer 90 and/or third layer 100 of the side walls 110 adjacent to the targets may be higher than corresponding thicknesses of the side walls 120 non-adjacent to the targets. Two targets 20, 20′ are represented at 180° azimuthal angles, but less of more targets may be used in the invention, and at different azimuthal angles. For examples, four targets may be used at 90° of each other, or two targets at 90° of each other. The return yoke of the cyclotron represented in FIG. 2 has a square outline, but, embodiments of the present disclosure may be used with a cyclotron having a circular outline. In that case, the shielding may be square as represented or cylindrical around the cyclotron. The angles formed by two side walls may be cut-off along a vertical plane at 45° of the side walls 110, 120 forming cut-off corners 140 or the angle between the side walls 110, 120 and the roof 130 may be cut-off at 45° forming cut-off corners 150. The amount of cut-off is measured by the distance cut-off from the side or roof L_{C-O}. These cut-off corners may result in significant reduction in size, weight, and cost of the shielding, without reducing the shielding efficiency.

The material of the different layers will now be discussed. The first layer 80 is made of a materiel having a high hydrogen content. This may ensure that the neutrons rapidly lose their energy. The material may be paraffin (paraffin wax). Paraffin is a composition comprising alkanes CₙH₂ₙ₊₂ where n is typically equal to 31 or in a range around 31. The density of paraffin is 0.9 g/cm³. Paraffin contains 0.132 g/cm³ of hydrogen. Polyethylene may also be selected as material for the first layer 80. Polyethylene has a hydrogen content between 0.13 g/cm³ and 0.137 g/cm³, depending on the density of the polymer. Also water may be used as material for the first layer. Water has a hydrogen content of 0.11 g/cm³. Paraffin or polyethylene first layers 80 may be built and assembled from blocks or sheets of material. A first layer 80 of water may be obtained by filling one or more containers having the appropriate shape.

The second layer 90 is made of a materiel having a high content of material having a high atomic number Z. A high Z material may be efficient in stopping the photons. A limited content of hydrogen-rich material is still needed for stopping the remaining neutrons. The high Z material is located outwards of the high hydrogen contents, in order to be able to stop the primary photons emitted by the target, but also the secondary photons produced during the loss of energy of the neutrons. The high Z material may be a material having Z equal or above 26, i.e. iron (Fe). Other materials may be used such as lead (Pb, Z=82) but is much more expensive. In the examples discussed below, the second layer comprises a volume filled with iron balls and with water filling the open spaces between the iron balls. When filling a volume with spheres having the same diameter, the closest packing produce a relative density (ratio of filled to open space) of 0.7408. When packed randomly in a volume, a relative density of 0.63 will be observed. When assumed to be in the closest packing, the second layer 90 will have an iron content of 5.83 g/cm³, and a hydrogen content of 0.028 g/cm³. When assumed to be randomly packed, the second layer 90 will have an iron content of 4.96 g/cm³, a water content of 0.37 g/cm³, and a hydrogen content of 0.0411 g/cm3. The observed density of a mixture in one example was 5.55 g/cm³. Also, a mixture of iron balls having different diameters, e.g. larger balls having a diameter in the range of 0.7 to 1.0 mm and smaller balls having a diameter in the range of 0.1 to 0.3 mm may be used. In that case, the smaller balls fill the spaces between the larger balls, and the iron content will be higher and the hydrogen content will be lower.

An optional third layer 100, used in only examples 1 and 2 below, is made of heavy concrete. Heavy concrete is regular concrete where the rock material is replaced by iron (III) oxide (Fe₂O₃). The density of heavy concrete (HC) is between 3.5 g/cm³ and 4.5 g/cm³.

In order to determine the optimal shielding design for an isotope production apparatus, a series of simulations was performed using the Monte Carlo (MC) simulation code MCNPX™ 2.7.0 from Los Alamos National Laboratory, according to the following hypotheses:
A cyclotron producing an H-beam and irradiating a target for the production of FDG;
The target is located in the return yoke of the cyclotron;
The cyclotron and target are enclosed in a closely encompassing shielding (self-shielded design);
   In the following, seven examples, embodying different hypotheses relating to the shielding, are discussed.

TABLE 1

| | | | | | | | | Angle |
|---|---|---|---|---|---|---|---|---|
| Example # | L1 | L2_{target} | L2_{non-target} | L2ₜₒₚ | L3_{target} | L3_{non-target} | L3ₜₒₚ | cut-off L_{C-O} |
| 1 | 30 cm | 40 cm | 30 cm | 30 cm | 40 cm | 30 cm | 30 cm | 25 cm |
| 2 | 0 | 60 cm | 60 cm | 60 cm | 30 cm | 20 cm | 20 cm | 25 cm |
| 3 | 30 cm | 60 cm | 50 cm | 50 cm | 0 | 0 | 0 | 25 cm |
| 3′ | 30 cm | 60 cm | 50 cm | 50 cm | 0 | 0 | 0 | 25 cm |
| 4 | 0 | 80 cm | 70 cm | 80 cm | 0 | 0 | 0 | 25 cm |
| 5 | 30 cm | 50 cm | 40 cm | 40 cm | 0 | 0 | 0 | 25 cm |
| 6 | 25 cm | 50 cm | 40 cm | 40 cm | 0 | 0 | 0 | 25 cm |
| 7 | 30 cm | 60 cm | 50 cm | 50 cm | 0 | 0 | 0 | 50 cm |
| 8 | 30 cm | 60 cm | 50 cm | 50 cm | 0 | 0 | 0 | 70 cm |

L1 Layer 1 Paraffin
L2 Layer 2 Iron balls + water
L3 Layer 3 (optional) Heavy concrete

### Example 1

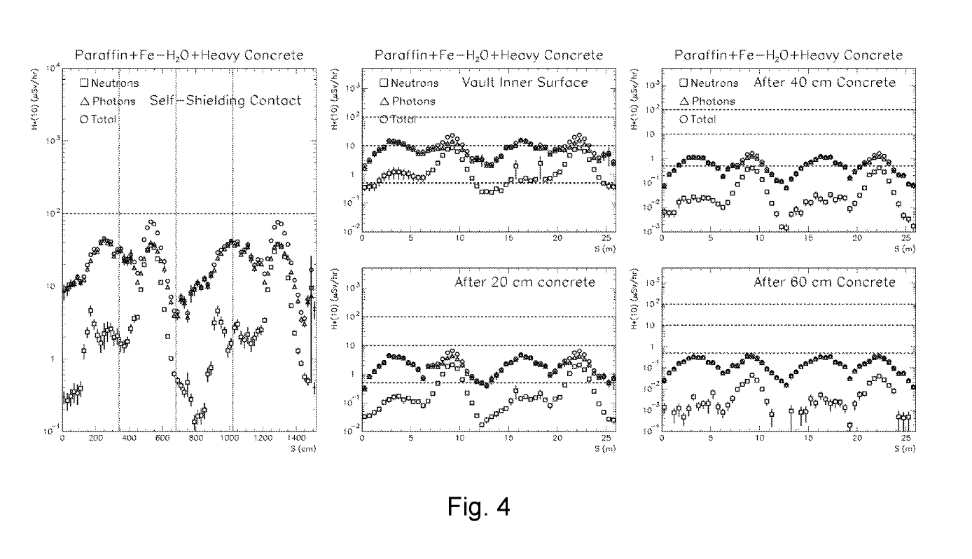

FIG. 4 represents sets of dose rate values obtained at different locations with the shielding parameters of example 1. These results show that with an additional vault shielding of 0 cm (no vault shielding), the limit for controlled area is exceeded while with an additional vault shielding of 20 cm, the dose rate remains below the limit for controlled area, and with an additional vault shielding of 40 cm, the limit for public area is exceeded and with an additional vault shielding of 60 cm, the dose rate remains below the limit for public area.

### Example 2

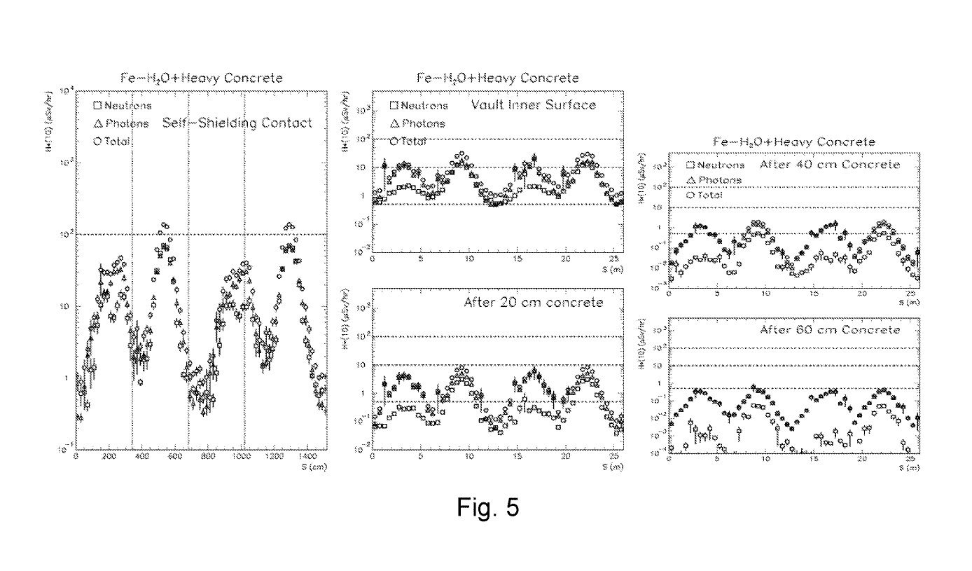

FIG. 5 represents sets of dose rate values obtained at different locations with the shielding parameters of example 2. In this example, no paraffin layer is used, and the Fe/H2O layer is thicker. These results show that with an additional vault shielding of 0 cm (no vault shielding), the limit for controlled area is exceeded while with an additional vault shielding of 20 cm, the dose rate remains below the limit for controlled area, and with an additional vault shielding of 40 cm, the limit for public area is significantly exceeded and with an additional vault shielding of 60 cm, the dose rate slightly exceeds the limit for public area. One may thus conclude that a hydrogen rich layer is necessary for a satisfactory solution.

### Example 3

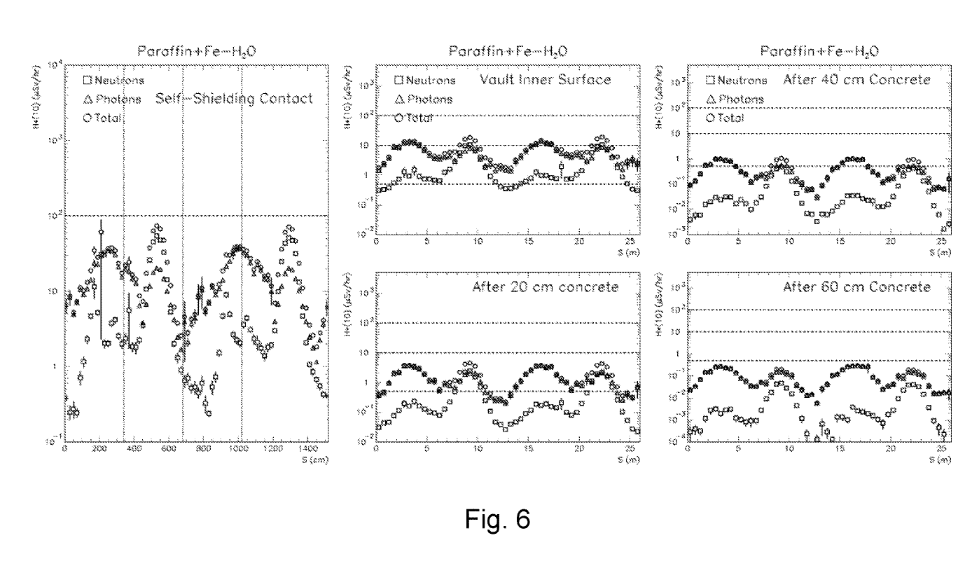

FIG. 6 represents sets of dose rate values obtained at different locations with the shielding parameters of example 3. These results show that with an additional vault shielding of 0 cm (no vault shielding), the limit for controlled area is exceeded while with an additional vault shielding of 20 cm, the dose rate remains below the limit for controlled area with some security margin, and with an additional vault shielding of 40 cm, the limit for public area is exceeded and with an additional vault shielding of 60 cm, the dose rate remains below the limit for public area also with some security margin.

### Example 3′

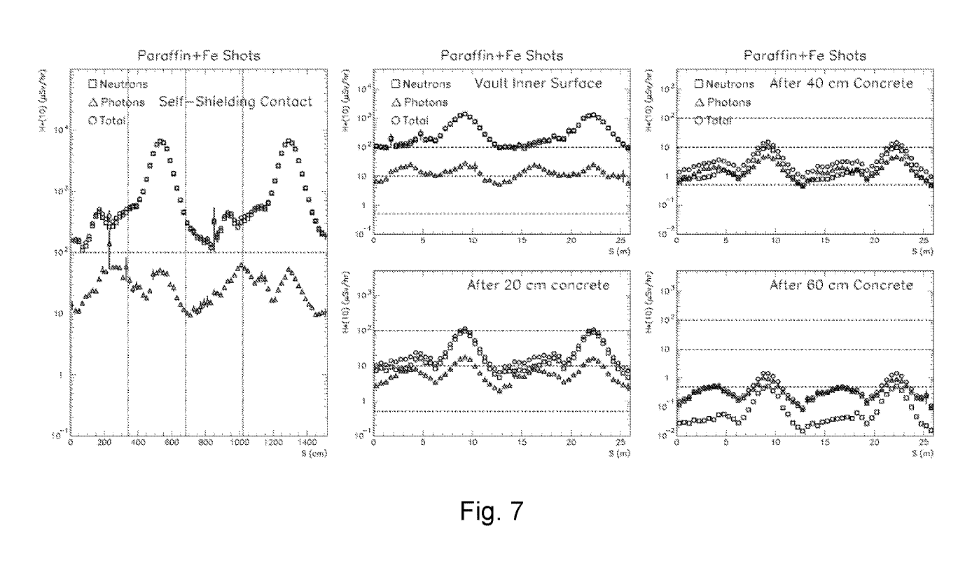

FIG. 7 represents sets of dose rate values obtained with the shielding parameters of example 3 with the only difference that no water is used for filling the space between the iron balls. In such an example, it is not required that a container for containing the second layer be water-tight. These results clearly show that both with an additional vault shielding of 20 cm, the limit for controlled area is exceeded, and with an additional vault shielding of 60 cm, the limit for public area is also exceeded. The most important contribution to the total dose comes from the neutron dose. One may thus conclude that the hydrogen-rich component is an important aspect of the solution. Alternatives to water may include other hydrogen-rich materials such as paraffin of polyethylene, which also do not require a water-tight container.

### Example 4

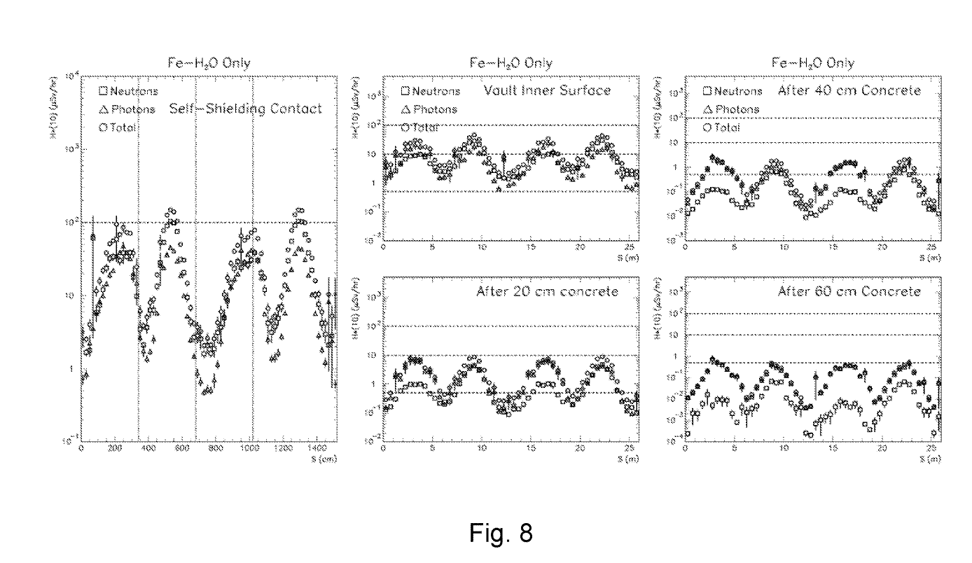

FIG. 8 represents sets of dose rate values obtained at different locations with the shielding parameters of example 4. In this example, only the second layer is used, with iron balls and water. These results show that with an additional vault shielding of 20 cm, the dose rate remains below the limit for controlled area with no security margin left, and with an additional vault shielding of 60 cm, the limit for public area is slightly exceed.

Table 2 gives, for the examples 1, 2, 3, 4, the weight of the individual components of the encompassing shielding, taking into account the weight reduction due to the cut-off of the angles between two vertical side walls (Corners Barril) and between a vertical side wall and the roof (roof corners) with a cut-off distance of 25 cm. These figures show that although the shielding of example 1 just meets the dose rate requirements, it is much heavier that the shielding of example 3. Examples 2 and 4, at the limit of the dose rate requirements are much heavier that the other examples. The shieldings of examples 1 and 3 are lighter, and the shielding of example 3 is both lighter and has only two layers.

TABLE 2

| | | | | Corners | Corners | HC | |
|---|---|---|---|---|---|---|---|
| Example # | Paraffin | Fe-H₂O | HC | Barril | Roof | (−corners) | Total |
| 1 | 5.55 T | 49.64 T | 51.31 T | −7.20 T | −12.83 T | 31.28 T | 86.47 T |
| 2 | 0 | 82.23 T | 34.11 T | −3.68 T | −6.20 T | 24.23 T | 106.47 T |
| 3 | 5.55 T | 102.85 T | 0 | −11.24 T | −20 T | | 77.15 T |
| 4 | 0 | 148.48 T | 0 | 0 | 0 | 0 | 148.48 T |

### Example 5

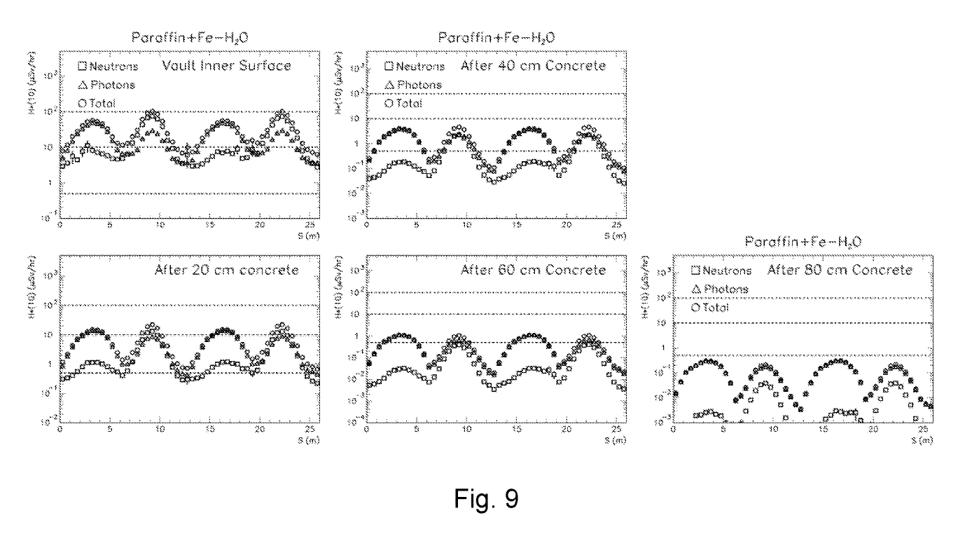

FIG. 9 represents sets of dose rate values obtained at different locations obtained with the shielding parameters of example 3 with the only difference that the thickness of the second layer is reduced from 60 cm to 50 cm at the target-side walls and from 50 cm to 40 cm at the non-target side walls and at the roof. An additional result is obtained for an additional vault shielding of 80 cm. These results show that neither 40 cm nor 60 cm are sufficient for staying below the limit for public area, but that with an additional vault shielding of 80 cm, the dose rate remains below the limit for public area (maximal value 0.3 μSv/h) with a significant safety margin.

### Example 6

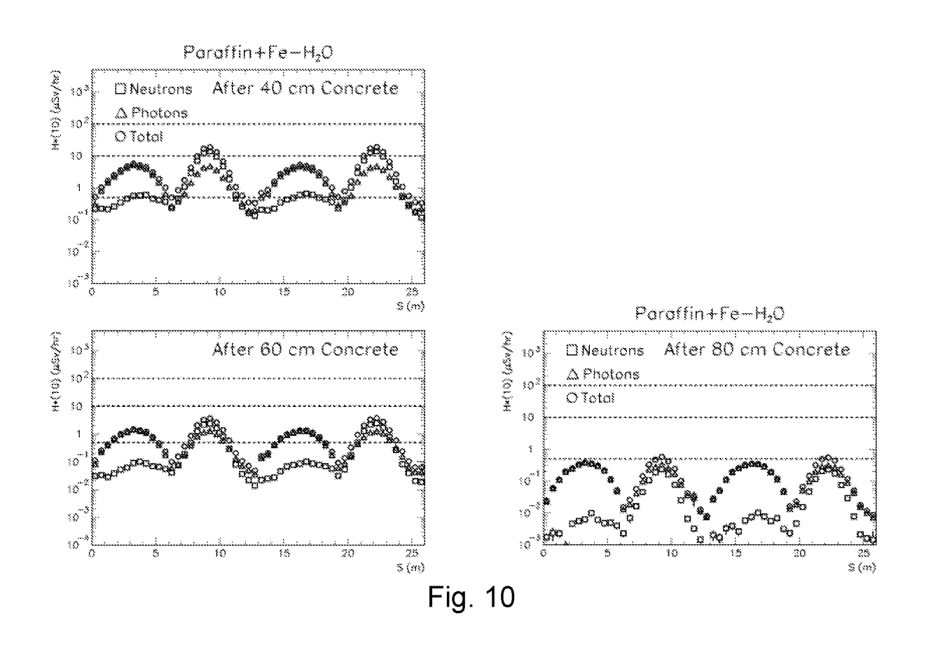

FIG. 10 represents sets of dose rate values obtained at different locations obtained with the shielding parameters of example 5 with the only difference that the thickness of the first layer (paraffin layer) is reduced from 30 cm to 25 cm. Also in this example, an additional result is obtained for an additional vault shielding of 80 cm. These results show that even with an additional vault shielding of 80 cm, the limit for public area is exceeded (maximal value 0.54 μSv/h)

### Example 7 and 8

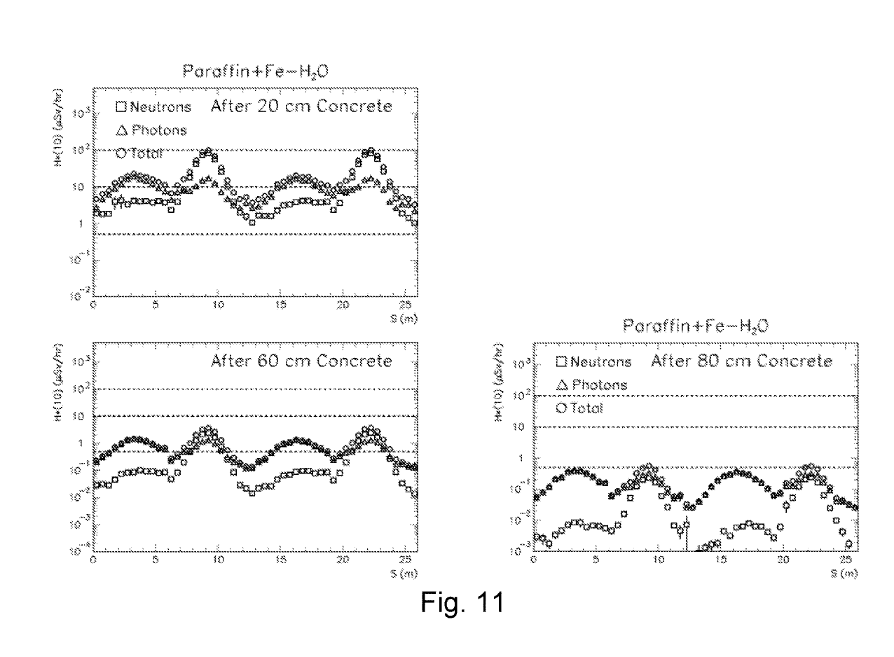

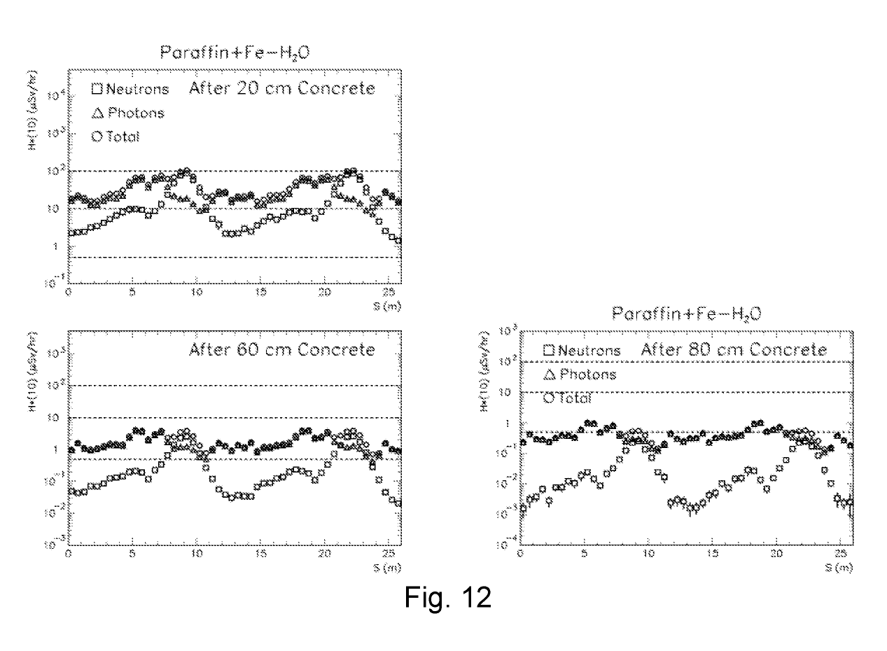

FIGS. 11 and 12 represents sets of dose rate values obtained at different locations obtained with the shielding parameters of example 3 with the only difference that the cut-off distance L_{C-O} is increased from 25 cm to 50 cm and 70 cm respectively. Also in this example, an additional result is obtained for an additional vault shielding of 80 cm. These results show that with an additional vault shielding of 60 cm, the limit for public area is exceeded both with 50 cm cut-off (example 7) and 75 cm cut-off (example 8). With an additional vault shielding of 80 cm, dose rate remains below the limit for public area in example 7 but not in example 8.

A self-shielded isotope production apparatus according to embodiments of the present disclosure allows the construction of a system where the self-shielded isotope production apparatus is located in a vault having walls of limited thickness, while meeting the requirement of limited dose rate in the public area outside the vault. In embodiments wherein the second layer comprises a volume filled with iron balls, it may be convenient to prepare the vessel or vessels in a factory, and to transport these vessels on-site, together with iron balls, and fill the vessels with iron balls and water on-site. The transport of very heavy components may thereby be avoided.

1. An isotope production apparatus, comprising:
a cyclotron for producing a particle beam;
a shielding surrounding the cyclotron; and
at least one target for irradiation by the particle beam and surrounded by the shielding,
wherein the shielding comprises a first layer having a hydrogen content of at least 100 kg/m³; and
a second layer having at least 4900 kg/m³ of material having an atomic number equal to or higher than 26 and at least 29 kg/m³ of hydrogen.

2. The isotope production apparatus according to claim 1, wherein the first layer comprises at least one of paraffin, polyethylene or water.

3. The isotope production apparatus according to claim 1, wherein the second layer comprises a volume filled with iron balls and with water filling the open spaces between the iron balls.

4. The isotope production apparatus according to claim 1, wherein a ratio of a thickness of the second layer to a thickness of the first layer is between 1 and 2.

5. The isotope production apparatus according to claim 1, wherein the first layer has a thickness between 25 and 30 cm.

6. The isotope production apparatus according to claim 1, wherein the second layer has a thickness between 50 and 60 cm.

7. The isotope production apparatus according to claim 1, wherein the cyclotron comprises a magnet having a central axis, and wherein a cross-section normal to the central axis of the outer surface of the magnet has a circular geometry concentric with the central axis.

8. The isotope production apparatus according to claim 1, wherein the cyclotron comprises a magnet having a central axis, wherein a cross-section normal to the central axis of the outer surface of the magnet has a geometry inscribed in a square concentric with the central axis, and wherein the shielding further comprises four side walls adjacent to the square and a roof covering the four side walls.

9. The isotope production apparatus according to claim 8, wherein the at least one comprises one target being at an azimuthal angle around the central axis closest to a side wall, and a side wall that is adjacent to the target having a thickness higher than a side wall that is non-adjacent to the target.

10. The isotope production apparatus according to claim 8, wherein external angles between the side walls or between the side walls and the roof are cut off.

11. The isotope production apparatus according to claim 10, wherein the cut-off is a 45° cut-off at a distance between 25 cm and 50 cm from said external angles.

12. The isotope production apparatus according to claim 8, wherein the at least one target comprises two targets being at azimuthal angles around the central axis closest to a side wall, and a side wall that is adjacent to a target having a thickness higher than a side wall that is non-adjacent to a target.

13. The isotope production apparatus according to claim 1, wherein the second layer comprises a volume filled with iron balls and with paraffin filling the open spaces between the iron balls.

14. The isotope production apparatus according to claim 1, wherein the second layer comprises a volume filled with iron balls and with polyethylene filling the open spaces between the iron balls.

15. The isotope production apparatus according to claim 1, wherein the second layer comprises a volume filled with iron balls of a first diameter and with iron balls of a second diameter, wherein the first diameter is larger than the second diameter.

16. The isotope production apparatus according to claim 15, wherein the first diameter is between 0.7 mm and 1.0 mm.

17. The isotope production apparatus according to claim 15, wherein the second diameter is between 0.1 mm and 0.3 mm.

18. The isotope production apparatus according to claim 1, wherein the target further comprises a third layer made of heavy concrete.

19. The isotope production apparatus according to claim 1, wherein the second layer comprises a volume filled with lead balls and with water filling the open spaces between the lead balls.

20. The isotope production apparatus according to claim 1, wherein the second layer comprises a volume filled with lead balls and with at least one of paraffin or polyethylene filling the open spaces between the lead balls.
